(19) United States
(12) Patent Application Publication
(10) Pub. No.: US 2024/0310529 A1
(43) Pub. Date: Sep. 19, 2024

(54) SIGNAL TRANSIT TIME-SELECTIVE FLASH LIDAR SYSTEM AND METHOD FOR OPERATION THEREOF

(71) Applicant: ams-OSRAM International GmbH, Regensburg (DE)

(72) Inventor: Farhang GHASEMI AFSHAR, Wenzenbach (DE)

(73) Assignee: ams-OSRAM International GmbH, Regensburg (DE)

(21) Appl. No.: 18/576,286

(22) PCT Filed: Jun. 23, 2022
(86) PCT No.: PCT/EP2022/067285

§ 371 Date: Jan. 3, 2024

(30) Foreign Application Priority Data
Jul. 5, 2021 (DE) 10 2021 117 333.7

(51) Int. Cl. G01S 17/894; G01S 7/481; G01S 7/4865; G01S 17/18; G01S 17/93

(52) U.S. Cl. CPC G01S 17/894; G01S 7/4814; G01S 7/4865; G01S 17/18; G01S 17/93

(57) ABSTRACT

The invention relates to a time-of-flight selective flash LiDAR system comprising an emitter for emitting pulsed illumination radiation into an object space; a detection unit with an image sensor for detecting the radiation reflected back from the object space; and a sensor control device for time-of-flight selection, wherein the sensor control device is configured such that the back-reflected radiation is detected separately from a first measuring surface and a second measuring surface and wherein the second measuring surface is located at a greater distance from the detection unit than the first measuring surface. The invention is characterized in that there is an illumination field control arrangement which is synchronized in time with the sensor control device and is configured in such a way that the illumination radiation generates a first illumination field with a first solid angle extension on the first measuring surface and a second illumination field with a second solid angle extension on the second measuring surface, and the first solid angle extension is greater than the second solid angle extension.

### CROSS-REFERENCE TO RELATED APPLICATIONS

The present application is a national stage entry from International Application No. PCT/EP2022/067285, filed on Jun. 23, 2022, published as International Publication No. WO 2023/280587 A1 on Jan. 12, 2023, and claims priority from the German application DE 10 2021 117 333.7 filed on Jul. 5, 2021, the disclosures of all of which are hereby incorporated by reference in their entirety.

### FIELD

The present invention relates to a time-of-flight selective flash LiDAR system with an emitter for emitting pulsed illumination radiation and a sensor control device for the time-of-flight selection of a detection unit as well as a method for operating a time-of-flight selective flash LiDAR system.

### BACKGROUND

LiDAR (Light Detection and Ranging) technology for environmental detection is well known and is used in particular in vehicle and space technology for autonomous systems. The measuring principle used is time-of-flight (ToF) measurement, whereby an emitter generates an optical signal to illuminate an object space and a detection unit records the echo signal reflected back from an object located there based on the time of flight, resulting in angle-resolved distance information in addition to the reflection characteristics of the object. Class 1 lasers in the near infrared (780 nm-1.6 μm, for example 1550 nm), which are harmless to the human eye, are often used as emitters. Although it is possible to use a continuously emitting laser for a LiDAR system, emitters in pulsed mode are usually preferred to reduce the noise signal caused by ambient light effects.

LiDAR systems can be divided into raster LiDAR and flash LiDAR. A combination of both systems is also possible. For a raster LiDAR, an angle-sensitive emitter is used that emits a beam of light in different spatial directions. A rotating mirror or a micromirror array can be used to guide the beam. It is also known to use adaptive optics downstream of the emitter for a raster LiDAR, for example liquid crystal optics, for the sequential movement of an illumination beam through the object space to be detected.

An angle-sensitive detection unit, usually an image sensor and preferably an IR image sensor, is used for flash LiDAR. Possible alternatives are mechanically tracked, movable photo sensors or adaptive optics connected upstream of the sensor for the angular resolution of an object echo. For illumination, the emitter in a flash LiDAR is usually configured in such a way that the object space to be detected is illuminated as a whole, whereby pulsed flash LiDAR systems are used, for example with a pulse duration in the nanosecond range and a pulse repetition rate of e.g. 30 Hz. Thus, instead of a moving, collimated light beam, a light cone with a sufficiently large beam angle is used for a flash LiDAR, which is usually formed by means of beam expansion optics downstream of the emitter and which generates a horizontally extended, preferably rectangular illumination field in the object space in the area of a measuring surface.

A further development of the flash LiDAR is the use of time-of-flight selective detection (range-gating). For this purpose, the detection unit is synchronized with the illumination pulse generated by the emitter. The signal detection by the detection unit then takes place with a defined time offset to the emission of the illumination pulse and a measurement duration matched to the illumination pulse duration, so that a predetermined measurement area with a defined distance to the flash LiDAR system is selected for the detection of the echo signal. The term “measurement area” is used here because the depth of the measurement volume actually present with the radiation propagation is so limited due to the illumination pulse duration typically selected in the range of a few nanoseconds that essentially the areal extent lateral to the propagation direction is relevant for the detected parts of the object space. A mostly sequential variation of the time interval between the generation of the illumination pulse and the start of signal acquisition by the detection unit enables the selection of several depth-staggered measurement areas. Such a range-gated imaging Flash-LiDAR is referred to as a time-of-flight selective Flash-LiDAR system.

When using a time-of-flight selective flash LiDAR system for autonomous vehicles, the problem arises that eye protection in particular requires power-limited emitters, so that the illumination intensity is often insufficient for the reliable detection of objects at a distance of 200 m and more, for example. For this reason, object tracking methods have been proposed for which limited, spatially moving measurement areas are illuminated separately. This approach leads to a complex time-of-flight selective flash LiDAR system that does not capture environmental data in all relevant areas of the object space.

### SUMMARY

The invention is based on the object of specifying a time-of-flight selective flash LiDAR system, in particular for autonomous systems, which provides a high information density from a large area of the object space. Furthermore, an operating method for a time-of-flight selective flash LiDAR system is to be provided, which enables simplification of data processing.

The object is solved by the time-of-flight selective flash LiDAR system mentioned in claim 1. Claim 13 recites the features of the method according to the invention for operating the time-of-flight selective flash LiDAR system, and further embodiments are the subject of the subclaims.

The starting point of the invention is a time-of-flight selective flash LiDAR system. This comprises an illumination system with an emitter, preferably an IR laser, for emitting pulsed illumination radiation into an object space and a detection unit with an image sensor for detecting the radiation reflected back from the object space. A sensor control device is used for the time-of-flight selection, which is configured in such a way that the back-reflected radiation is detected separately from a first measuring surface and a second measuring surface in the object space, whereby it is assumed here that the second measuring surface is located at a greater distance from the detection unit than the first measuring surface. It is preferable to measure the back reflection of a large number of depth-staggered measuring surfaces. The selection of the respective measuring surface is carried out by a sensor control device for the time-of-flight selection, which is synchronized in time with the illumination field control arrangement. The temporal offset between the emission of the illumination pulse by the emitter for the respective measurement surface and a measurement duration matched to the illumination pulse duration is therefore set by the illumination field control arrangement.

To solve the problem, the inventors recognized that illumination concentrated on a compact illumination field with a correspondingly high luminance should be used for a measuring surface in the far range. This provides more precise measurement data for the classification of distant objects, whereby model- or AI-based data processing can be simplified and more accurate. For the close range, a wide-area illumination field is required, whereby a lower luminance is sufficient. At close range, the widest possible field of view is desired in order to detect as many objects as possible in the immediate vicinity. In accordance with the invention, the illumination field control arrangement is therefore configured such that the illumination radiation generates a first illumination field with a first solid angle extension on the first measuring surface and a second illumination field with a second solid angle extension on the second measuring surface, and the first solid angle extension is selected to be larger than the second solid angle extension. The solid angle extension assigned to the respective illumination field refers to the solid angle that the electromagnetic radiation emitted by the illumination system occupies on the measurement surface under consideration.

In particular for the application of the time-of-flight selective flash LiDAR system according to the invention in autonomous vehicles, it is preferred to design the successive increase of the solid angle extension with a decreasing distance of the illumination field to the detection unit in such a way that the horizontal extension of the illumination field increases, since the close range is particularly relevant for the detection of the traffic environment.

The orientation for determining the horizontal extension is defined relative to the coordinate system of the time-of-flight selective flash LiDAR system, whereby a cylindrical or spherical coordinate system is used as the basis and the horizontal extension is determined along a lateral surface of the illumination field. This orientation corresponds to that of an ambient coordinate system if the time-of-flight selective flash LiDAR system is in a neutral position relative to the environment. For a system moving in a vehicle, the horizontal extension of the illumination field in relation to the surrounding coordinate system is understood in the sense of a temporal averaging. Furthermore, the horizontal extension for an illumination field that is not approximately rectangular is determined as an averaged extent of the generatrices defined by horizontal sections over the entire illumination area.

The solid angle extension of the illumination fields in the respective measuring surfaces can be adapted in different ways. According to a first variant, the illumination system comprises an adaptive optic that follows the emitter in the illumination beam path, whereby the illumination field control arrangement is configured to control the adaptive optic.

For a second variant, different light sources with separate static optics are used. Consequently, the emitter for the second variant comprises a first light source and a second light source, each of which emits pulsed illumination radiation in different spatial directions of the object space. The illumination field control arrangement for the second variant is configured so that the first light source supplies illumination radiation to the first illumination field and the second light source only contributes to the illumination of the second illumination field. It is also possible for the first light source to supply both the first illumination field and the second illumination field. Consequently, different light sources can be combined with each other to realize the distance-adapted extension of the respective illumination field according to the invention. It is also possible to use several light sources together with one or more adaptive optics.

The adaptive optics used for the first variant can comprise liquid crystal optics that follow the emitter in the illumination beam path. The liquid crystal optics can be designed in one piece or there is an arrangement with several liquid crystal optics modules. For a further development, a temperature control device is assigned to the liquid crystal optics, which ensures sufficient temperature stability for operation, particularly for autonomous systems exposed to changing ambient temperatures.

For a further embodiment of both variants, the emitter can comprise at least one surface-emitting IR laser diode (VCSEL). This allows the optical beam guidance to be simplified, as surface-emitting IR laser diodes provide electromagnetic radiation with good collimation. This is particularly advantageous if liquid crystal optics are used as adaptive optics. Alternatively or additionally, collimating optics arranged between the emitter and the liquid crystal optics can be used.

In some embodiments, the detection unit has an image sensor for detecting the back-reflected radiation from the object space and the sensor control device is configured so that the measurement of the back-reflected radiation from the first measuring surface and from the second measuring surface is performed with a time delay. The time-of-flight selective flash LiDAR system therefore operates with a time delay.

In some embodiments, the detection unit comprises a first image sensor with a first static imaging system adapted to the first illumination field and a second image sensor with a second static imaging system adapted to the second illumination field. If there are more than two illumination fields, the number of image sensors is increased accordingly.

In some embodiments, the centroids of the illumination fields lie on a straight line. Furthermore, it is possible for a further design that the connecting lines between the center of the detection unit and the centroids of the respective illumination fields point in different directions and/or that these directions vary in time, so that the time-of-flight selective flash LiDAR system is extended with additional functions of a raster LiDAR to form a hybrid system.

The method according to the invention for operating a time-of-flight selective flash LiDAR system uses an illumination field control arrangement which generates a first illumination field with a first solid angle extension in a first measuring surface and a second illumination field with a second solid angle extension in a second measuring surface, the first solid angle extension being selected to be greater than the second solid angle extension if the first measuring surface is located closer to the detection unit than the second measuring surface. This ensures that the illuminated near field is detected with a large opening angle. As a result, there is preferably a higher number of measurement data in the near environment, which is particularly relevant for collision avoidance in autonomous navigation. In the distant environment, the power density of the illumination can be increased due to the concentration on a narrower field of view, so that the data processing required for object recognition is less complex and overall improved accuracy in the classification of object properties is ensured.

### BRIEF DESCRIPTION OF THE DRAWINGS

Exemplary embodiments of the invention are explained below in connection with figure illustrations. These show, in each case schematically, the following:

FIG. 1 shows a first embodiment of the time-of-flight selective flash LiDAR system according to the invention.

FIG. 2 shows the course of the illuminated solid angle R as a function of the distance D to the detection unit.

FIG. 3 shows a second embodiment of the time-of-flight selective flash LiDAR system according to the invention.

FIG. 4 shows an illumination system with a liquid crystal optics as an adaptive optics in a first focusing position.

FIG. 5 shows an illumination system from FIG. 4 with the liquid crystal optics in a second focusing position.

FIG. 6 shows a second variant of the time-of-flight selective flash LiDAR system according to the invention.

FIG. 7 shows a time-of-flight selective flash LiDAR system according to the state of the art.

### DETAILED DESCRIPTION

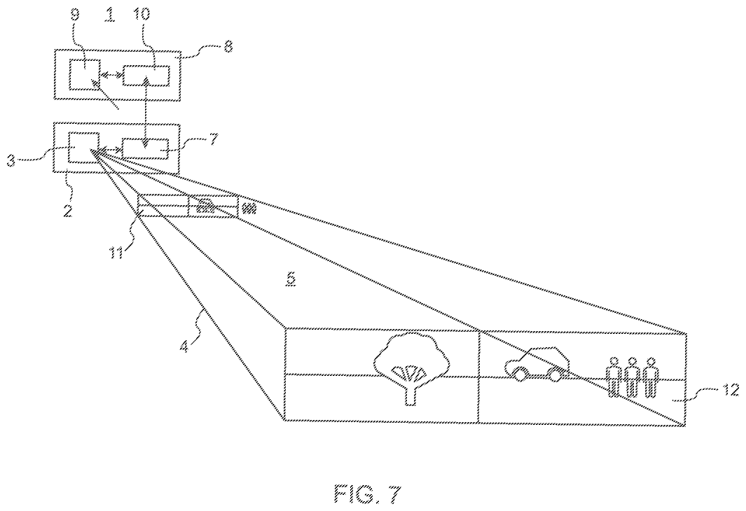

The schematically simplified time-of-flight selective flash LiDAR system 1 shown in FIG. 7 corresponds to the known state of the art. It shows an illumination system 2 with an emitter 3, for example an eye-safe IR laser, which emits pulsed illumination radiation 4 into an object space 5. Furthermore, the illumination system 2 comprises an illumination field control arrangement 7, which controls the emitter 3 and determines the pulse duration and the pulse spacing. Furthermore, a detection unit 8 with an image sensor 9 is shown, which detects the radiation reflected back from the object space 5. The detection unit 8 also has a sensor control device 10, which is synchronized in time with the illumination field control arrangement 7, whereby different measuring surfaces in the object space are selected by varying the delay time for the start of the measurement relative to the time of emission of the pulsed illumination radiation 4. The measurement duration is selected to be very short and matched to the pulse duration in the nanosecond range. Consequently, a quasi-two-dimensionally extended measuring surface is considered instead of a measuring volume extended in depth. As an example, a first measuring surface 11 and a second measuring surface 12 are shown in FIG. 7, whereby the first measuring surface 11 is closer to the detection unit 8 than the second measuring surface 12, so that the first measuring surface 11 represents the near range of the object space 5 and the second measuring surface 12 represents the far range.

According to the state of the art, the illumination system 2 generates an illumination beam 4 that is emitted with a constant solid angle extension. As a result, the extension of the illumination field present on the respective measuring surface also increases with increasing distance from the illumination system 2 and the illumination power density decreases. As a result, objects in the far field in the area of the second measuring surface 12 are only detected with greater effort for data processing and are taken into account for object tracking with a delay. Concentrating the radiant power on a narrower solid angle to solve the problem is only possible to a certain extent, as otherwise the extension of the first measuring surface 11 at close range is not sufficient to detect all objects located there. This is particularly relevant when using a time-of-flight selective flash LiDAR system 1 for an autonomous vehicle, as objects in the direct vicinity of the vehicle pose a risk of collision and must be reliably localized and assigned to an object type.

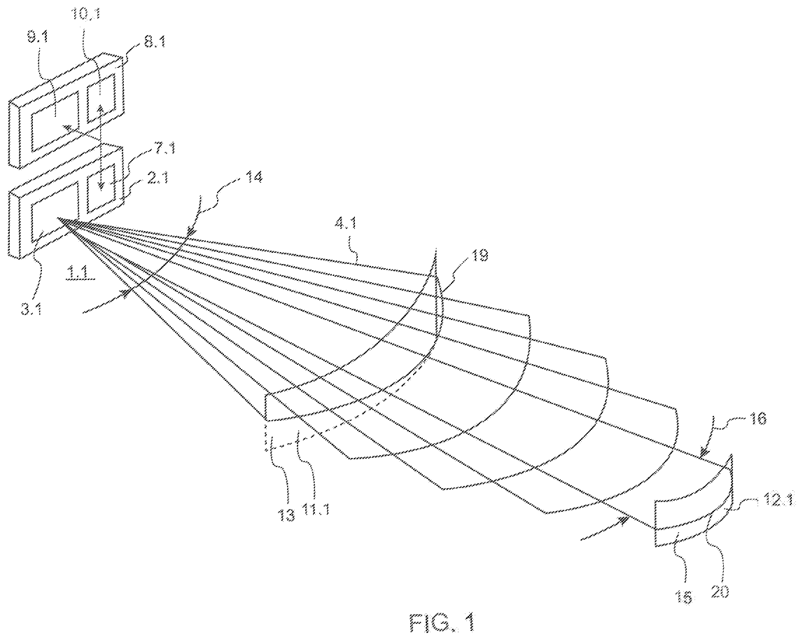

FIG. 1 shows a first example of the time-of-flight selective flash LiDAR system 1.1, which provides a solution to the problem described above. It is shown that the illumination field control arrangement 7.1 of the illumination system 2.1 is configured to control the emitter 3.1 in such a way that the pulsed illumination radiation 4.1 creates a first illumination field 13 with a first solid angle extension 14 on a first measuring surface 11.1 and a second illumination field 15 with a second solid angle extension 14 on a second measuring surface 12.1, a second illumination field 15 with a second solid angle extension 16 is generated, whereby for the first illumination field 13 located at a smaller distance from the detection unit 8, the first solid angle extension 14 is larger than the second solid angle extension 16 of the more distant second illumination field 15 according to the invention. This provides a large solid angle R for near-field detection, which is gradually narrowed as the distance D to the selected measuring surface increases, so that in the far field the radiation is concentrated to a narrow solid angle R. Accordingly, when viewing a horizontal section, a first horizontal extension 19 of the first illumination field 13 is greater than a second horizontal extension 20 of the second illumination field 15.

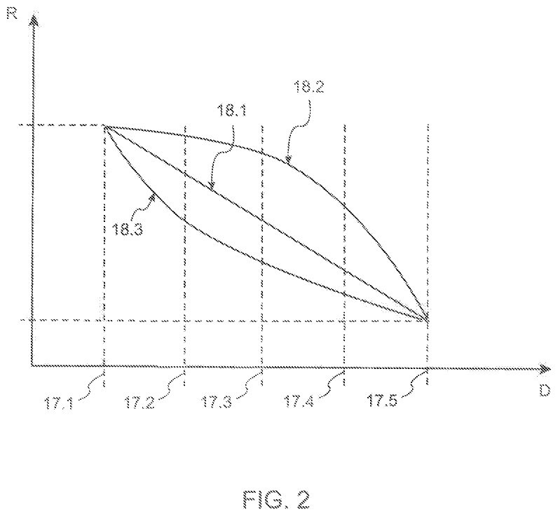

FIG. 2 shows possible curves of the illuminated solid angle R as a function of the distance D to the detection unit, whereby a linear solid angle curve 18.1, a solid angle curve 18.2 favoring the near field and a solid angle curve 18.3 giving greater weight to the far field are shown. Another advantage is a time-variable setting of the solid angle curve, which is not shown in detail, for adaptation to the prevailing driving and ambient conditions.

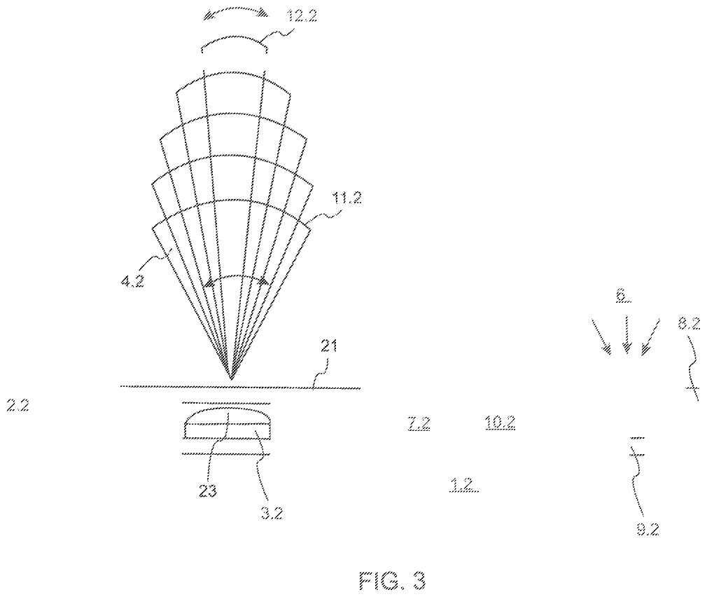

FIG. 3 shows a second embodiment of the time-of-flight selective flash LiDAR system 1.2 according to the invention. An illumination system 2.2 with an emitter 3.2 comprising a surface-emitting IR laser diode 22 is shown. Furthermore, the illumination system 2.2 has an illumination field control arrangement 7.2, which generates the solid angle characteristic for the illumination radiation 4.2 according to the invention, using adaptive optics 21 for this purpose. In addition, a collimating optic 23 is arranged in the beam path between the emitter 3.2 and the adaptive optic 21.

The detection unit 8.2 with the image sensor 9.2 and the sensor control device 10.2 detects the back-reflected radiation from the first measuring surface 11.2 with a time offset relative to the back-reflected radiation from the second measuring surface 12.2. A zoom system 24 is also provided and the sensor control device 10.2 is used for its time-sequential adjustment, so that a variable imaging scale on the zoom system 24 and/or a focal plane are adapted to the respective illumination field of the measuring surface 11.2, 12.2 to be selected.

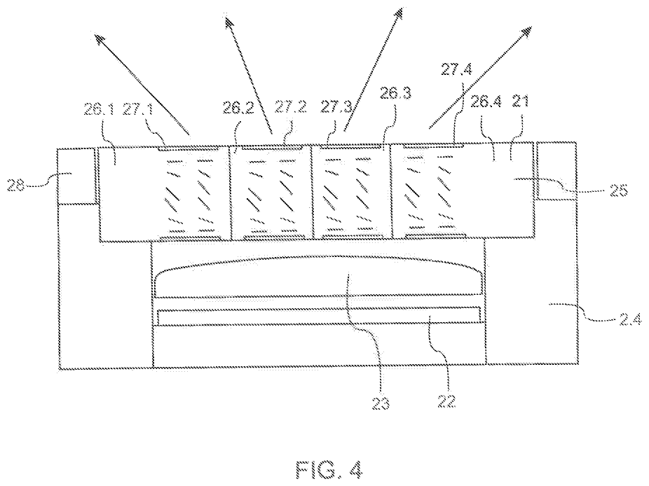

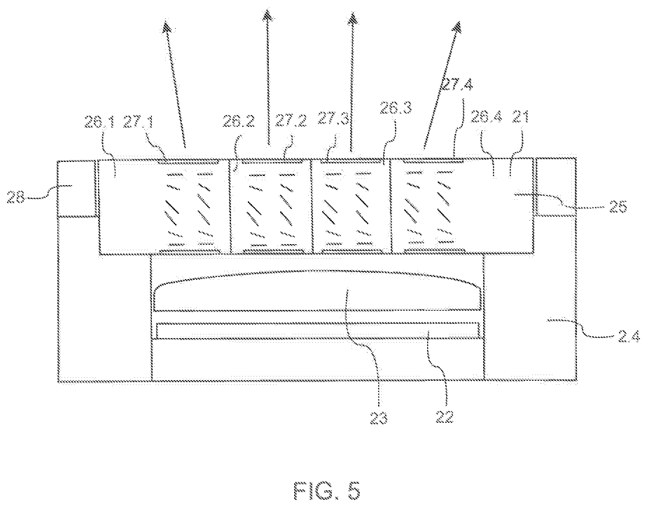

FIGS. 4 and 5 show a preferred embodiment of an illumination system 2.4 comprising an adaptive optics 21 with a liquid crystal optics 25 comprising a plurality of liquid crystal optics modules 26.1, 26.2, 26.3, 26.4. Each of the liquid crystal optics modules 26.1, 26.2, 26.3, 26.4 has a transparent electrode arrangement 27.1, 27.2, 27.3, 27.4 for setting a field gradient, with FIG. 4 showing a first focusing position for which an illumination field with a large solid angle extension results. In comparison, the second focusing position shown in FIG. 5 provides an illumination field with a reduced solid angle extension. Furthermore, a temperature control device 28 is provided for maintaining a predetermined working temperature for the liquid crystal optics 25.

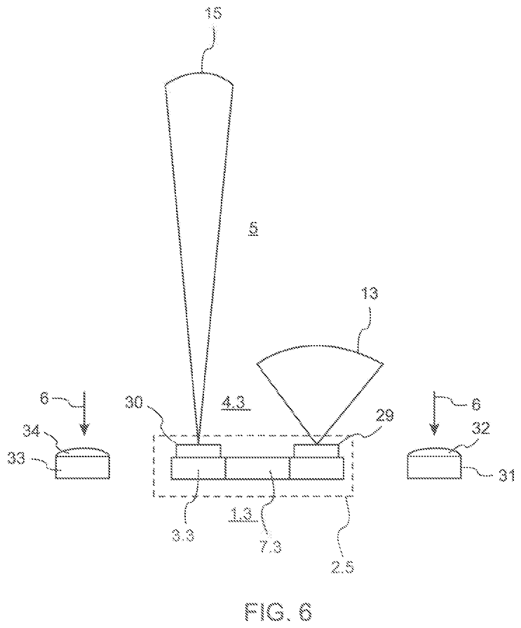

FIG. 6 shows a second variant of the time-of-flight selective flash LiDAR system 1.3 according to the invention. An illumination system 2.5 with an emitter 3.3 and a illumination field control arrangement 7 is shown. 3 for generating the solid angle characteristic for the illumination radiation 4.3 according to the invention. The emitter 3.3 has a first light source 29 and a second light source 30, each of which emits pulsed illumination radiation in different spatial directions of the object space 5. The illumination field control arrangement 7.3 controls the first light source 29 so that it supplies illumination radiation 4.3 to a first illumination field 13 and the second light source 30 generates illumination radiation for the second illumination field 15. Furthermore, a first image sensor 31 with a first static imaging system 32 adapted to the first illumination field 13 is available for the detection unit 8.3. A second image sensor 33 is assigned a second static imaging system 34, which is adapted to the solid angle extension and the distance of the second illumination field 15.

1. A time-of-flight selective flash LiDAR system comprising:
an illumination system with an emitter for emitting pulsed illumination radiation into an object space;
a detection unit with an image sensor for detecting the radiation reflected back from the object space; and
a sensor control device for time-of-flight selection, wherein the sensor control device being configured in such a way that the back-reflected radiation is detected separately by a first measuring surface and a second measuring surface,
wherein the second measuring surface is located at a greater distance from the detection unit than the first measuring surface;
wherein an illumination field control arrangement synchronized in time with the sensor control device is present, which is configured in such a way that the illumination radiation generates a first illumination field with a first solid angle extension on the first measuring surface and a second illumination field with a second solid angle extension on the second measuring surface,
wherein the first solid angle extension is greater than the second solid angle extension,
wherein the illumination system comprises an adaptive optics, and
wherein the illumination field control arrangement is configured to control the adaptive optics.

2. The time-of-flight selective flash LiDAR system according to claim 1, characterized in that a first horizontal extension of the first illumination field is greater than a second horizontal extension of the second illumination field.

3. (canceled)

4. The time-of-flight selective flash LiDAR system according to claim 1, characterized in that the adaptive optics comprises a liquid crystal optics.

5. The time-of-flight selective flash LiDAR system according to claim 4, characterized in that the illumination system comprises a temperature control device for the liquid crystal optics.

6. The time-of-flight selective flash LiDAR system according to claim 4, characterized in that a collimation optics is arranged between the emitter and the liquid crystal optics.

7. The time-of-flight selective flash LiDAR system according to claim 1, characterized in that
the emitter comprises a first light source and a second light source, which each emit pulsed illumination radiation in different spatial directions of the object space, and
the illumination field control arrangement is configured such that the first light source supplies illumination radiation to the first illumination field or to the first illumination field and the second illumination field and the second light source supplies illumination radiation only to the second illumination field.

8. The time-of-flight selective flash LiDAR system according to claim 1, characterized in that the emitter comprises a surface-emitting IR laser diode.

9. The time-of-flight selective flash LiDAR system according to claim 1, characterized in that the sensor control device is configured in such a way that the detection of the back-reflected radiation from the first measuring surface is delayed with respect to the detection of the back-reflected radiation from the second measuring surface.

10. The time-of-flight selective flash LiDAR system according to claim 1, characterized in that the detection unit comprises a zoom system and the sensor control device is configured to adapt a variable imaging scale and/or a focal plane of the zoom system to the respective illumination field detected by the detection unit.

11. The time-of-flight selective flash LiDAR system according to claim 1, characterized in that the detection unit comprises a first image sensor with a first static imaging system adapted to the first illumination field and a second image sensor with a second static imaging system adapted to the second illumination field.

12. A method for operating a time-of-flight selective flash LiDAR system according to claim 1,
wherein the illumination field control arrangement generates on a first measuring surface a first illumination field with a first solid angle extension and on a second measuring surface a second illumination field with a second solid angle extension, wherein the first measuring surface is located closer to the detection unit than the second measuring surface; and
wherein the first solid angle extension is set larger than the second solid angle extension by the illumination field control arrangement.
